(19) United States
(12) Patent Application Publication
(10) Pub. No.: US 2007/0059581 A1
(43) Pub. Date: Mar. 15, 2007

(54) Electrochemical cell component

(76) Inventor: Peter Andrin, Ontario (CA)

Correspondence Address: Thomas W Gorman;E I Du Pont De Nemours and Company, Legal Patent Records Center, 4417 Lancaster Pike, Wilmington, DE, 19805, US

(21) Appl. No.: 10/550,423

(22) PCT Filed: Mar. 24, 2004
(86) PCT No.: PCT/CA04/00441

§ 371 Date: Oct. 24, 2005

Related U.S. Application Data
(60) Provisional application No. 60/457,280, filed on Mar. 25, 2003.

(51) Int. Cl. H01M 8/02; H01M 4/94

(52) U.S. Cl. 429/38; 429/44; 429/42

(57) ABSTRACT

An electroconductive integrated substrate and a process of producing the same, which comprises a porous conductive gas diffusion layer having large number of pores with significant gas permeability, and a gas impermeable electroconductive flow field plate having landing surfaces laminated on the surface of gas diffusion layer and integrally bonded to thereto by the molten composite from the landing surface. There is provided a process for joining the gas diffusion layer to a flow field plate in an electrochemical cell. The process comprises the step of welding the landing surface of the flow field plate to the gas diffusion layer using resistance welding.

### FIELD OF THE INVENTION

The present invention relates to an electrochemical cell component formed by joining a cell separator plate to a porous gas diffusion layer. In particular, the gas diffusion layer is welded to landing surfaces on the separator plate.

### BACKGROUND OF THE INVENTION

Electrochemical cells, and in particular fuel cells, have great future potential. Electrochemical cells comprising polymer electrolyte membrane (PEMs) may be operated as fuel cells wherein a fuel and an oxidant are electrochemically converted at the cell electrodes to produce electrical power, or as electrolyzers wherein an external electrical current is passed between the cell electrodes, typically through water, resulting in the generation of hydrogen and oxygen at the respective electrodes of the cell.

FIG. 1a illustrates a typical PEM electrochemical cell. Each cell comprises a membrane electrode assembly (MEA) disposed between a pair of separator plates 5. The MEA comprises a catalyst-coated membrane 10 interposed between a pair of fluid distribution layers 15, which are typically porous and electrically conductive. The fluid distribution layers 15 are commonly referred to as gas diffusion layers (GDLs). The catalyst-coated membrane 10 comprises an electrocatalyst on both sides for promoting the desired electrochemical reaction. The electrocatalyst generally defines the electrochemically active area of the cell. The MEA is typically consolidated as a bonded laminated assembly of catalyst coated membrane and gas diffusion layers or an unbonded assembly, where the catalyst-coated membrane 10 is sandwiched between two GDLs 15 and is compressed to form the MEA.

The cell separator plates 5 are typically manufactured from graphite or electrically conductive plastic composite materials such as graphite composite made of graphite powders and graphite fibers held together by polymer resin materials. Fluid flow spaces, such as passages or chambers, are provided between the separator plate 5 and the adjacent GDL 15 to facilitate access of reactants to the catalyst layer through the GDL 15, and facilitate removal of reaction by-products. Such spaces are formed more commonly as channels in the face of the separator plate 5 that abuts the GDL 15. Separator plates 5 comprising such channels are commonly referred to as flow field plates. In conventional PEM cells, the ribs of these channels, commonly termed as “landings”, function as the electrical contact between the flow field plate 5 and GDL 15. Resilient gaskets or seals are typically provided between the faces of the MEA and each separator plate 5 around the periphery of the plates 5 to prevent leakage of fluid reactant and product streams.

The GDLs 15 are typically made of porous, electrically conductive non-corrosive material, such as carbon cloth or carbon paper. The GDLs 15 provide uniform fuel and oxidant distribution to the catalyst-coated membrane 10 and facilitates the transport of product water from the catalyst layers to the flow field plates 5. The GDLs 15 also provide electrical contact between the catalyst layers and flow field plates 5, which helps in the harvesting of electrons from the electrochemical reaction in the electrocatalyst layers.

The morphology, composition, porosity, tortuosity, thickness and compression ratio of the GDL 15 impact the overall performance of the electrochemical cell under different operating conditions. The nature and extent of contact between the GDLs 15 and the flow field plates 5 significantly contributes to the overall performance of the electrochemical cells. Good contact between the GDLs 15 and flow field plates 5 results in optimum cell performance by decreasing the resistive loss between the GDLs 15 and the flow field plates 5.

PEM electrochemical cells are advantageously stacked to form an electrochemical stack (see FIG. 1b) comprising a plurality of cells disposed between a pair of end plates 20. A compression mechanism (not shown) is employed to hold the plurality of cells tightly together, to maintain good electrical contact between the cell components, such as the plates 5 and GDLs 15, and to compress the seals. The stack compression force controls the nature and extent of contact between the GDLs 15 and the flow field plates 5. While a high stack compression force may provide good contact between the GDLs 15 and flow field plates 5, it often can cause local damage to the physical structure of the GDLs 15. A high stack compression force can also change the morphology of the porous GDLs 15 and impede the flow of oxidant and fuel to the catalyst layers. This impediment can lead to starvation at the reactive sites on the catalyst layers and a resultant decrease in the performance of the electrochemical cell.

The non-uniform distribution of reactants across the active area of the cell may also cause differential reaction zones, leading to hot-zones being formed in the active area of the MEA. These hot-zones can then create pinholes in the membrane, resulting in the premature failure of the MEA.

Parts of the GDLs 15 may also sink into the flow field channels of the plates 5 when a high stack compression force is applied, resulting in added stress to the GDLs 15 and landing junctions. This leads to a restriction of the flow of reactants and products through the channels, which affects the overall performance of the electrochemical cell.

In addition, the uneven surfaces of the flow field plates 5, and the uneven landing surfaces of the flow field channels may cause uneven contact between the GDL 15 and the flow field plate 5. The thickness variation of the GDL 15 can introduce pressure differentials across the active electrochemical area of the MEA, resulting in a contact difference with the landing surfaces of the flow field plate 5. This uneven contact results in lower conductivity between the GDL 15 and flow field plate 5. It can also result in localized deformation of the GDL 15. Therefore, in such a stack unit, if the electrical contact resistance at the interface between the flow field plate 5 and the GDL 15 is large, the voltage drop is correspondingly large when a current is passed in the stacking direction, leading to a lower electrical efficiency in the electrochemical cell stack.

Typically, an assembled cell stack is subjected to high compression force applied through the end plates to increase the contact between the GDL and separator plates in an electrochemical cell. A method for compressing individual PEM cells within a stack for increasing the conductivity between the GDL and separator plates is disclosed in U.S. Pat. Nos. 5,534,362 and 5,736,269. These two patents describe a method of compressing PEM cells together, wherein the compression pressure is simultaneously produced in each cell by a pressurized fluid.

Attempts have also been made to increase the contact area between the GDL and landing surfaces of the flow field plates to reduce the resistive loss between these two layers. For example, U.S. Pat. No. 6,348,279 proposes a method to roughen the landing surfaces of the flow field plates to increase the overall area of contact and facilitate penetration of the roughened areas into the pores of the GDL to reduce the resistive loss and enhance the conductivity between flow field plate and GDL. However, the result of this process is largely dependent on the compression force applied to the stack, which determines the degree of penetration of the roughened plate landing surface into the pores of GDL. This therefore provides very little advantage over a non-roughened landing surface, as the overall stack conductivity remains dependent on the stack compression force.

Another common method disclosed in the prior art involves the corrugation of the actual separator plate itself as taught in U.S. Pat. No. 5,232,792. This method reduces electrical resistance by penetration of the corrugated plate surface into the pores of the GDL thus improving the electrical conductivity between the GDL and flow field plate. This method, however, is also dependent on the compression force applied to the stack.

U.S. Pat. No. 5,049,458 teaches the application of concave and convex portions to the surface of the separator plate to create a “wave-form” or dimpled corrugation pattern with flat electrodes. The dimples are hemispherical in shape and tangentially contact the flat electrode at the curved portion of the dimples and thus create good contact between the plate and the electrode.

To decrease the resistive loss between the separator plate and GDL, separator plates possessing unique dimple configurations have been proposed in U.S. Pat. No. 5,795,665. Each separator plate is formed with rows of dimples such that the dimples in successive rows protrude from the separator plates in opposing direction. The first separator plate abuts a first face of the PEM cell so that the dimples of the plate protruding in a first direction abut the dimples of the PEM cell protruding in the opposite or second direction. This opposite effect is said to create good contact between the GDL and the separator plate.

A unit combining a separator plate and a GDL is disclosed in U.S. Pat. No. 6,280,870. The combined unit is fabricated by incorporating a GDL bearing serpentine flow field channels into a recessed flat conductive plate surface. The channel landings formed on the GDL contacts the surface of the flat plate. There is no bonding between the GDL and the flat plate. The recessed surface of the flat plate helps to hold the GDL in place and prevents the GDL from getting dislocated during stacking of the cells, However, due to the absence of electrically conductive bonding between the landings of the GDL and the surface of the plate, the resultant conductivity between these two components remains dependent on the stack compression force. Higher force will result in better contact and hence lower resistive loss between the GDL and the surface of the plate. Similar concepts have also been disclosed in U.S. Pat. Nos. 5,252,410 and 5,300,370.

A method for improving the conductivity between the GDL and separator plates and to prevent the resilient GDL from sinking into the open-faced flow channel under stack compression force has been disclosed in U.S. Pat. No. 6,007,933. An electrically conductive support member with first and second sides is placed between the resilient GDL and the separator plate face. The support member is formed with a plurality of openings extending between the first and second sides. The first side of the support member abuts the separator plate face. The second side of the support member abuts the resilient GDL and prevents the GDL from entering the open-faced flow channel under a compressive force applied to the stack assembly. Thus, the support member acts as an additional layer between the plate and GDL, however, it contributes to the overall resistive loss of the stack assembly.

Another method that tries to develop a conductive contact between the GDL and the current collector plate is to use different thermoplastic adhesive films between the GDL and the plate. This is disclosed in E.P. patent number 0,330,124. Thin thermoplastic films are placed on the GDL that possess flow field landing surfaces. The GDL is heat pressed against the flat current collector plate to create an integrated laminated structure. The thermoplastic film gets impregnated into the pores of the GDL and the pores on the surface of the current collector plate to create a permanent bond between the two components. After bonding, the conductivity between the GDL and the plate becomes independent of the compression force applied to the stack. Unfortunately, being an electrical insulator, the thermoplastic adhesive film does not provide optimum conductivity between the GDL and the plate.

During operation of the electrochemical PEM cell stack, current output or utilization is limited by several factors. Ohmic resistance is the most significant limiting factor. Ohmic resistance is created within each PEM cell and by the interface between each PEM cell. This is described in a DOE Report “Understanding of Carbonate Fuel Cell Resistance Issues for Performance Improvement” Contract #DE-AC21-90MC27168. Further limitations are imposed by the backpressure created as the gases flow through each PEM cell when the GDL sinks into the flow field channels of the separator plate. Large current output requires high flow rates, which result in increased backpressure if the GDL occupies the channels unnecessarily. High backpressure tends to contribute to reactant gas leakage and hence to a mass transport problem, which reduces the overall stack efficiency.

There, therefore, remains a need to provide an electrochemical cell component having improved electrical contact between the GDL and the separator plate so that the conductivity between the GDL and plate is not dependent on stack compression force. This unitized GDL and plate component will be advantageous for providing continuous support of the fuel cell MEA, homogenized diffusion, permeability and GDL integrity, preventing the GDL from sinking into the flow field channels, providing better electrical contact between the GDL and the plate, and reducing the amount of stack compression force for satisfactory electrical conductivity between the MEA and the combined separator plate and GDL.

### SUMMARY OF THE INVENTION

In one aspect of the present invention, there is provided an electrochemical cell component comprising:
(a) a gas diffusion layer comprising a porous body; and
(b) an electroconductive separator plate comprising at least one landing surface formed on a surface of the separator plate, and the separator plate and landing surface comprising a polymer and conductive filler,
   wherein the gas diffusion layer is joined to the separator plate by impregnating some of the polymer on the landing surface within a portion of the porous body.

According to another aspect of the present invention, an integrated electroconductive cell component is provided that comprises a gas diffusion layer and a separator plate, the flow field plate comprising a polymer/graphite composition and having at least one landing surface, wherein said landing surface is integrally bonded to the gas diffusion layer.

In a further embodiment of the present invention, the integrated electroconductive cell component substrate module is made by laminating a porous gas diffusion layer having a large number of gas permeable pores and preferably having a thickness of 100 to 400 μm, to a gas impermeable electroconductive flow field separator plate, preferably having a thickness of 1 to 10 mm. The gas diffusion layer and the separator plate are joined together by heating the laminated structure by hot pressing, resistance welding, laser welding, ultrasonic welding or heat lamination, thereby melting the polymer at the junction of the landing surface of the separator plate and impregnating the polymer into the pores of the gas diffusion layer.

The preferred embodiments of the present invention can provide many advantages. For example, the integrated electroconductive cell component improves the contact between the GDL and landing surfaces of the flow field separator plates and provides uniform conductivity across the MEA and plates. It results in negligible resistive loss between the GDL and the plates, leading to better overall performance of the electrochemical cell stack. Other advantages include the cell component providing continuous support for the MEA, allowing for homogenized diffusion and permeability of the reactants and product fluids, allowing for uniform electrical contact between the GDL and the plate, preventing the sinking of GDL material into the open channels of the flow field plate thus keeping the reactant gas flow through the channels unaffected, and reducing the amount of stack compression needed for satisfactory electrical conductivity between the GDL and flow field plate.

Numerous other objectives, advantages and features of the process will also become apparent to the person skilled in the art upon reading the detailed description of the preferred embodiments, the examples and the claims.

### BRIEF DESCRIPTION OF THE DRAWINGS

The preferred embodiments of the present invention will be described with reference to the accompanying drawings in which like numerals refer to the same parts in the several views and in which:

FIG. 1a is an exploded perspective view of a typical polymer electrolyte membrane fuel cell;

FIG. 1b is an exploded perspective view of a typical polymer electrolyte membrane fuel cell as part of a fuel cell stack;

FIG. 2a is a partial side perspective view of a flow field plate and gas diffusion layer;

FIG. 2b is a close up view of flow field channels and landing surfaces on a flow field plate; and

FIG. 3 is a schematic drawing of a bond created between a flow field plate and a gas diffusion layer in accordance with a preferred embodiment of the present invention.

FIG. 4 illustrates the relationship between resistivity and compression pressure for a gas diffusion layer joined to a graphite/polymer composite flow field plate.

### DETAILED DESCRIPTION OF THE PREFERRED EMBODIMENTS

The preferred embodiments of the present invention will now be described with reference to the accompanying figures.

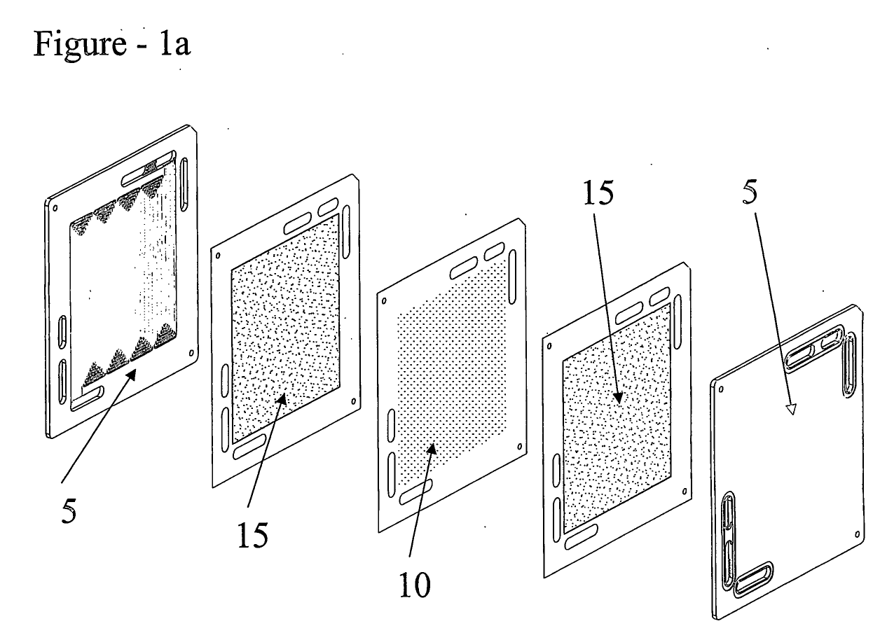

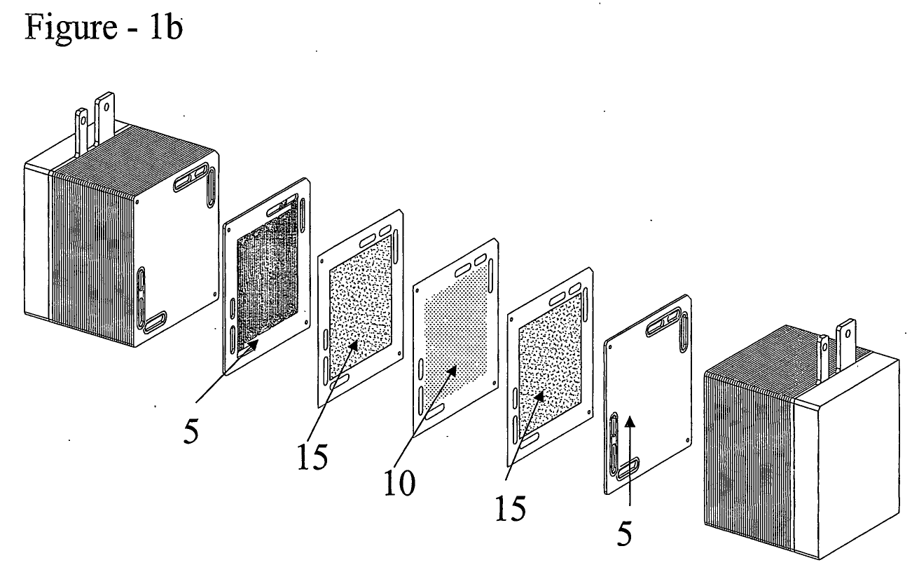

As shown in FIG. 1a, a typical polymer electrolyte membrane fuel cell comprises a MEA disposed between two flow field separator plates 5. The MEA includes a catalyst-coated membrane 10 between two gas diffusion layers (GDLs) 15. The GDLs 15 are adjacent to flow field plates 5, which form the outer layers of the fuel cell.

The flow field plates 5 comprise at least one flow field channel 20 that allows gas or liquid to flow within the electrochemical fuel cell. The flow field plates 5 typically carry either fuel or oxidant depending on the design of the electrochemical cell or electrochemical cell stack.

In a preferred embodiment, the present invention provides an integrated electroconductive cell component in which a GDL 15 is permanently bonded to a flow field separator plate 5 of a fuel cell by partially impregnating the polymeric composite plate material of the flow field plate 5 into the pores of the GDL 15.

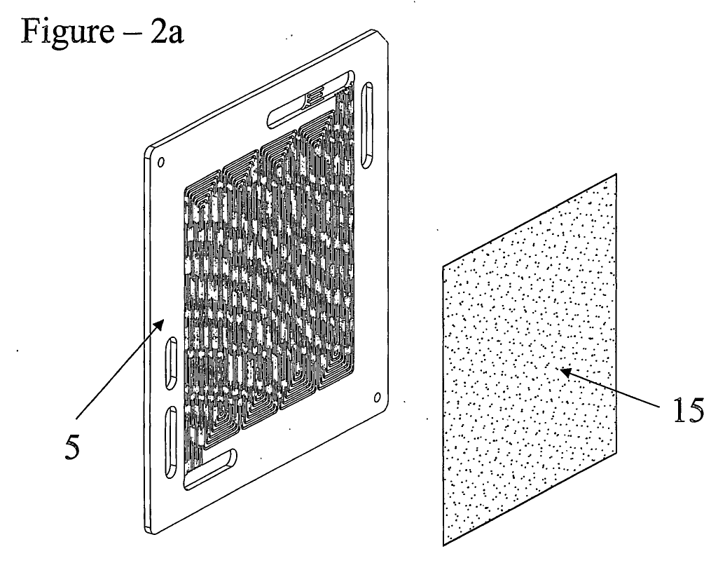

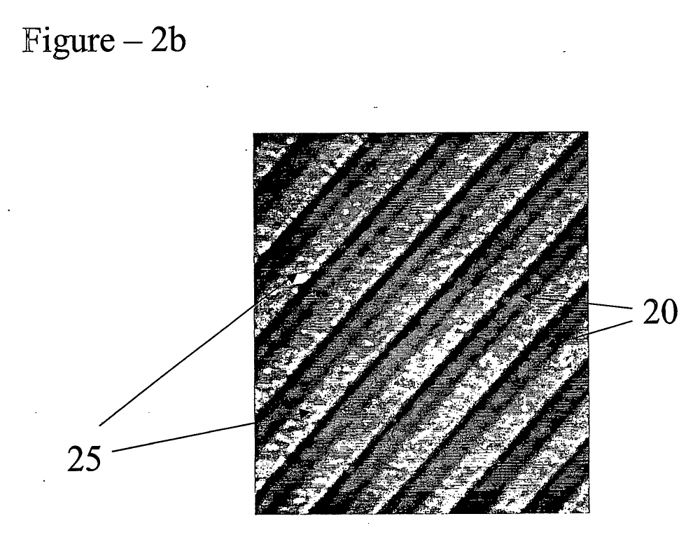

Impregnation of the composite material of the flow field plate 5, in particular the polymer component of the plate, is facilitated by the configuration and composition of the flow field plates 5. As shown in FIGS. 2a and 2b, the flow field channels 20 are configured with landing surfaces 25, which are raised surfaces that form the top barrier walls of the flow field channels 20. The dimensions of the landing surfaces 25 may vary according to the particular electrochemical cell design. In a preferred embodiment, both the width and height of the landing surfaces 25 are from 0.1 mm to 8.0 mm, preferably from 0.8 mm to 1.5 mm.

The separator plates 5 are generally moulded from a composition comprising a polymer resin binder and conductive filler, with the conductive filler being preferably graphite fibre and graphite powder. The polymer can be any thermoplastic polymer or any other polymer having characteristics similar to a thermoplastic polymer. The thermoplastic polymers can include melt processible polymers, such as Teflon® FEP and Teflon® PFA, partially fluorinated polymers such as PVDF, Kynar®, Kynar Flex®, Tefzel®, thermoplastic elastomers such as Kalrez®, Viton®, Hytrel®, liquid crystalline polymer such as Zenite®, polyolefins such as Sclair®, polyamides such as Zytel®, aromatic condensation polymers such as polyaryl(ether ketone), polyaryl(ether ether ketone), and mixtures thereof. Most preferably, the polymer is a liquid crystalline polymer resin such as that available from E.I. du Pont de Nemours and Company under the trademark ZENITE®. A blend of 1 wt % to 30 wt %, more preferably 5 wt % to 25 wt % of maleic anhydride modified polymer with any of the above-mentioned thermoplastic polymers, partially fluorinated polymers and liquid crystalline polymer resin and their mixture can also be used as binding polymer.

The graphite fiber is preferably a pitch-based graphite fiber having a fiber length distribution range from 15 to 500 μm, a fiber diameter of 8 to 15 μm, bulk density of 0.3 to 0.5 g/cm³ and a real density of 2.0 to 2.2 g/cm³. The graphite powder is preferably a synthetic graphite powder with a particle size distribution range of 20 to 1500 μm, a surface area of 2 to 3 m²/g, bulk density of 0.5 to 0.7 g/cm³ and real density of 2.0 to 2.2 g/cm³. Further details regarding the composition of the separator plates 5 are described in U.S. Pat. No. 6,379,795 B1, which is herein incorporated by reference.

In a preferred embodiment of the present invention, the separator plates 5 are molded from a composition as described in co-pending of PCT patent application no. PCT/CA03/00202 filed Feb. 13, 2003, the complete specification of which is hereby incorporated by reference. The composition includes from about 1 to about 50% by weight of the polymer, from about 0 to about 70% by weight of a graphite fibre filler having fibres with a length of from about 15 to about 500 microns, and from 0 to about 99% by weight of a graphite powder filler having a particle size of from about 20 to about 1500 microns. Preferably, the composition comprises:
a. from about 1 wt % to about 50 wt % of ZENITE® 800 aromatic polyester resin;
b. from about 0 wt % to about 70 wt % of pitch-based graphite fiber (fiber length distribution range: 15 to 500 micrometre; fiber diameter: 8 to 10 micrometre; bulk density: 0.3 to 0.5 g/cm³; and real density: 2.0-2.2 g/cm³); and
c. from about 0 wt % to about 99 wt % graphite powder (particle size distribution range: 20 to 1500 micrometre; surface area: 2-3 m²/g; real density: 2.2 g/cm³).

The GDLs useful in the present invention are generally made of porous, electrically conductive non-corrosive material, such as woven and non-woven carbon cloth or carbon paper, which are available under the trade names SGL, Lydall Technimat, Toray, Ballard Aucarb, Mitsubishi Rayon, Kureha isotropic, Zoltek, Freudenberg nonwovens, E-TEK “E-LAT”, Spectracorp Spectracet, and Conoco mesophase. The GDLs may have microporous layers deposited on their surfaces for controlling the shape and size of the pores, which is important to control the gas permeability of the GDLs. These GDLs can be treated with Teflon® for inducing hydrophobicity, which is useful for electrochemical cell operation. The GDLs provide uniform fuel and oxidant distribution to the catalyst-coated membrane and facilitates the transport of product water from the catalyst layers to the flow field separator plates. The GDLs also provide electrical contact between the catalyst layers and plates, which helps in the harvesting of electrons from the electrochemical reaction in the electrocatalyst layers.

To join the GDL 15 to the flow field plate 5, the GDL 15 is welded to the landing surfaces 25 using suitable joining techniques such as resistance welding and vibration welding. However, other techniques such as ultrasonic welding, laser welding, heat lamination, or hot bonding techniques may also be used.

The general process for resistance welding of two electrically conductive polymer composites is disclosed in U.S. Pat. No. 4,673,450, which is hereby incorporated by reference. However, its application to electrochemical cells and to a process of welding an electrically conductive polymer composite material with porous non-polymeric material has not yet been explored.

In the resistance welding process, an alternating or direct electrical current is used to create welds between the landing surfaces 25 and the GDL 15, thereby joining the landing surfaces 25 to the GDL 15. The electrical current is passed between the GDL 15 and flow field separator plate 5 while bringing the landing surfaces 25 and GDL 15 together. Pressure may also be applied to the GDL 15 and separator plate 5 to keep the GDL 15 and flow field plate 5 together. Preferably, during the resistive welding process, a constant pressure is applied to the GDL 15 to hold the GDL 15 against the landing surfaces 25.

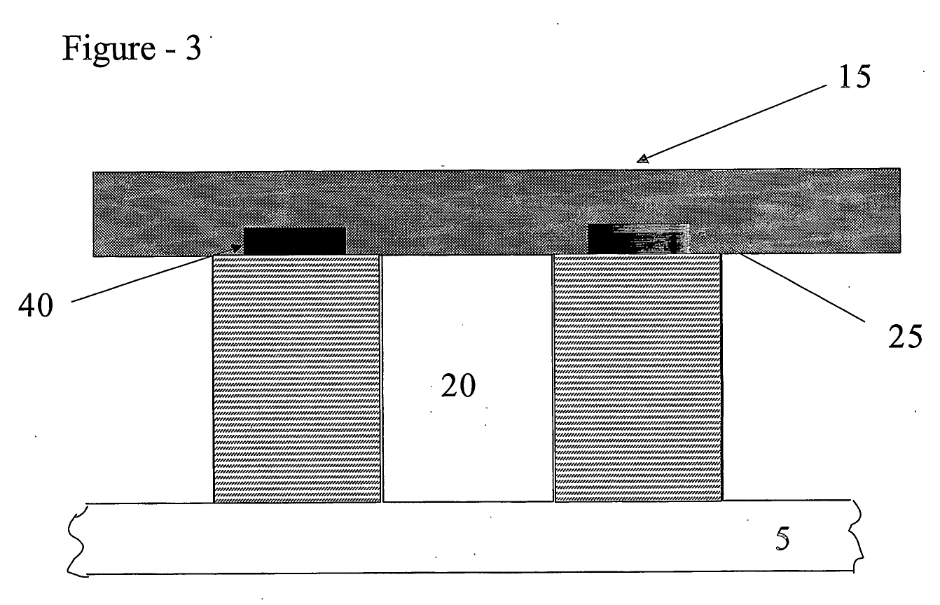

As the electrical current flows through the flow field separator plate 5 and GDL 15, the contact areas between the GDL 15 and landing surfaces 25 experience a relatively higher resistance, resulting in the production of localized heat at the contact areas. This localized heat causes the polymer component of the landing surfaces 25 to melt, allowing the conductive filler components of the landing surface 25 to establish direct contact with the carbon matrix of the GDL 15, thereby creating a contact region. When the polymer component of the landing surfaces 25 is molten, the flow of electrical current is stopped, thus also stopping the production of localized heat. As pressure continues to be applied between the GDL 15 and landing surfaces 25, the molten polymer component of the landing surfaces 25 impregnates into the pores of the GDL 15. With continued pressure applied, the molten polymer component of the landing surfaces 25 then solidifies into the pores of the GDL 15 and around the contact region as the polymer cools, thereby fusing the GDL 15 to the flow field separator plates 5 at the landing surfaces 25. Since localized heat production stops when the electrical current is withdrawn, the temperature of the separator plates 5 drops quickly to a temperature well below the glass transition temperature of the polymer. As a result, the molten polymer hardens and the fused areas between the landing surfaces 25 and GDL 15 form a permanent weld 40 (see FIG. 3).

The electrical current can be applied directly to the flow field separator plates 5 and GDL 15 using electrodes. The amperage, voltage, design pressure and span of electrical current flow will vary depending on the polymer resin material used, the surface area of the landing surfaces 25, the size of the pores of the GDL 15 and the degree of melting at the landing surfaces 25. However, in a preferred embodiment, the applied electrical current is between about 0.01 amperes/mm² and about 5 amperes/mm², preferably between about 0.8 and about 1.1 amperes/mm², and its voltage is between about 1 and about 10 volts, preferably between about 3 and about 5 volts. The electrical current is applied for a time of from about 0.1 to about 10 seconds, preferably from about 0.5 to about 4 seconds and the applied pressure is between about 1 and about 200 psig, preferably between about 10 and about 120 psig, more preferably between about 30 and about 70 psig.

The electroconductive integrated cell component formed by joining the GDL 15 to the flow field separator plates 5 can be used to create a fuel cell that includes the GDL 15 permanently fused to the plates 5 within the fuel cell. This fuel cell design will have significant advantages such as improved efficiency, low stack clamping force and decreased production time.

With the vibration welding technique, a vibration welding machine is used to create a vibrational force amongst and between the GDL 15 and the flow field separator plates 5. The GDL 15 and plates 5 are brought together and placed so that the GDL 15 is in contact with the landing surfaces 25. The vibrational force can be applied to both the GDL 15 and the flow field separator plate 5, or either one of the GDL 15 or plate 5 while keeping the other stationary.

The continued vibrational force on the GDL 15 and the flow field separator plates 5 causes the contact area between the GDL 15 and landing surfaces 25 to become frictionally engaged, resulting in the production of localized heat which melts the polymer component present in the composite material at the landing surfaces 25. When the vibrational force is reduced or is stopped, localized heat production is diminished or eliminated and the GDL 15 and the landing surfaces 25 are cooled, solidifying the localized molten polymer and fusing the area between the GDL 15 and the landing surfaces 25. Pressure is preferably applied to the GDL 15 and the flow field plate 5 during cooling to cause the molten polymer composition to impregnate into the pores of the GDL 15. The preferred pressure applied is between about 1 and about 200 psig, preferably between about 10 and about 120 psig, more preferably between about 30 and about 70 psig.

The landing surfaces 25 of the flow field separator plates 5 are configured so that during vibration welding of the plates 5 and GDL 15 only the landing surfaces 25 are in contact with the GDL 15, while the rest of the plate 5 is not in contact with the GDL 15. As shown in FIG. 3, this configuration allows the polymer component in the landing surfaces 25 to melt during vibration.

The amplitude, frequency and application time of the vibrational force applied to the GDL 15 and the flow field separator plate 5 determines the extent to which the landing surfaces 25 will fuse with the GDL 15. In a preferred embodiment, the vibrational is applied for a time of about 3 to about 100 seconds, at a frequency of about 100 to about 500 cycles per second and amplitude of about 0.5 mm to about 5 mm. It will be apparent to a person skilled in the art that the amplitude, frequency and vibrational timing of the vibrational welding process is designed to complement the impregnation of the polymer of the landing surfaces 25 into the pores of the GDL 15.

The quality of the weld between the GDL 15 and landing surface 25 created by the welding process can further be improved by providing a polymer rich material or pure polymer layer to the landing surfaces 25 of the flow field separator plate 5. The plate 5 may therefore be polymer rich at a localized area on the top surface of the landing surfaces 25. In a preferred embodiment, the localized area is 0.002″ to 0.100″ thick and more preferably 0.020″ thick. This localized area comprises between about 25 wt % and about 100 wt % polymer, preferably between about 50 wt % and about 100 wt % polymer, and most preferably about 100 wt % polymer.

The following examples illustrate the various advantages of the preferred method of the present invention.

### EXAMPLES

Composite separator plates comprising 25% Zenite® 800, 55% Thermocarb® graphite powder and 20% graphite fiber were welded to three different gas diffusion layers, namely E-TEK “E-LAT” carbon cloth, Zoltek®, and Ballard Aucarb®. E-TEK® carbon cloth comprises a weaved carbon cloth material and has a regular metric structure. Zoltek® cloth comprises a woven carbon cloth material. It has an irregular surface porosity. Ballard Aucarb® comprises a small porous structure and has increased rigidity when compared with E-Tek® and DeNora Zoltek®.

A jig was used to apply a direct current mediated by two electrodes directly to the composite plate and gas diffusion layer. A welding machine was used as a power source. The jig also applied and controlled the pressure on the composite plate and gas diffusion layer. A gas cylinder was used as the pressure source.

### Example 1

A composite plate bearing a landing surface was joined to a gas diffusion layer comprising porous E-Tek® carbon cloth. The landing surface of the plate had a length of 60 mm, a width of 20 mm and a thickness of 4 mm. The composite plate and the gas diffusion layer were placed in the jig (for Butt welding position) and a 70-ampere (70 A) current was passed through the composite plate and gas diffusion layer for 3.5 seconds. A pressure of 60 psig was applied to hold the gas diffusion layer against the landing surfaces of the plate. After application of the electrical current, the gas diffusion layer was held against the landing surface of the plate using the weld pressure of 60 psig. Once the integrated gas diffusion layer and plate were cooled to room temperature, the pressure was released and electrical conductivity of the integrated component was measured.

### Example 2

A composite plate similar to the one described in Example-1 was used to join to a gas diffusion layer comprising porous Zoltek® carbon cloth obtained from DeNora. Zoltek® gas diffusion layer was placed on the landing surface of the plate and both were then placed in the resistive welding jig and held at a pressure of 55 psig. A 90-ampere electrical current was applied through the electrodes for 3.5 seconds. The pressure was held at 55 psig until the joined cell component was cooled down to room temperature. Once cold the pressure was removed and the conductivity of the joined electroconductive component was determined.

### Example 3

A composite plate similar to the one described in Example-1 was used to join to a gas diffusion layer comprising porous Zoltek® carbon cloth obtained from DeNora. Zoltek® gas diffusion layer was placed on the landing surface of the plate and both were then placed in the resistive welding jig and held at a pressure of 55 psig. A 60-ampere electrical current was applied through the electrodes for 3.0 seconds. The pressure was held at 55 psig until the joined cell component was cooled down to room temperature. Once cooled, the pressure was removed and the conductivity of the joined electroconductive component was determined.

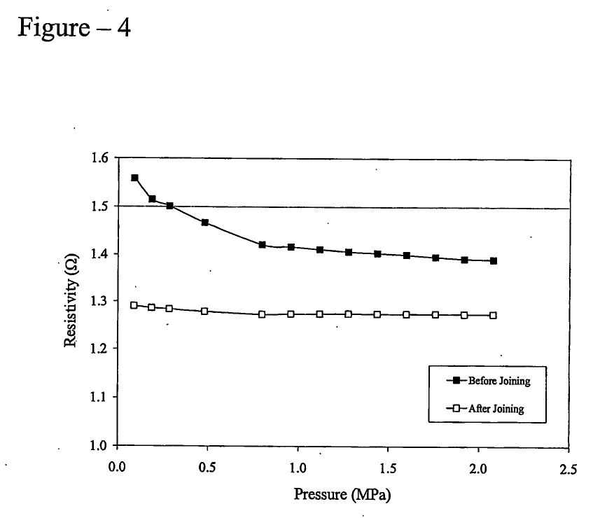

FIG. 4 compares the resistivity of the joined Zoltek®-composite plate system to a system where the Zoltek® carbon cloth is not welded to the plate. From FIG. 4, it will be noted that the resistivity of the welded component remains essentially constant as compression pressure increases, and in fact remains constant at 1.24Ω when the compression force is increased from 0.5 MPa to 2.0 MPa. In contrast, the resistivity of the system where the gas diffusion layer is not welded to the plate decreases significantly as the compression pressure increases to about 0.8 MPa. Then, the resistivity remains fairly constant at about 1.4 MPa as the pressure is increased from 0.8 to 2.0 MPa.

Thus, from FIG. 4, it will be seen that the resistivity of the component welded in accordance with a preferred embodiment of the process of the present invention is less than the resistivity of the non-welded system (1.24Ω compared to 1.4Ω). As well, the resistivity of the welded component is essentially not dependent on the compression pressure whereas the resistivity of the non-welded system is dependent on compression pressure, especially at pressures less than 0.8 MPa.

### Example 4

Ballard Aucarb® gas diffusion layer was joined to the composite plate described in Example-1 using resistive welding method as described in Examples 1 and 2. A welding current of 90-ampere was applied for 3.5 seconds to the gas diffusion layer and plate while a pressure of 50 psig was applied. Once the plates were cooled to room temperature, the pressure was removed and the integrated Ballad Aucarb® gas diffusion layer and composite plate was subjected to conductivity measurements.

As discussed earlier, gas diffusion layers comprising different surface morphology and pore structure require different welding conditions. In each case, welding of the four different gas diffusion layers to the landing surface was achieved. Table 1 compares the variation in welding conditions for four different gas diffusion layers.

TABLE 1
Welding Parameters and Conductivity Gain

| | E-TEK | | | |
|---|---|---|---|---|
| | Carbon | | | Ballard |
| Welding | Cloth | Zoltek ® | Zoltek ® | Aucarb ® |
| Parameters | (Example 1) | (Example 2) | (Example 3) | (Example 4) |
| Current (amp) | 70 | 90 | 60 | 90 |
| Pressure (psig) | 60 | 55 | 55 | 50 |
| Weld Time (s) | 3.0 | 3.5 | 3.0 | 3.5 |

Although the present invention has been shown and described with respect to its preferred embodiments and in the examples, it will be understood by those skilled in the art that other changes, modifications, additions and omissions may be made without departing from the substance and the scope of the present invention as defined by the attached claims.

1. An electrochemical cell component comprising:
(a) a gas diffusion layer comprising a porous body; and
(b) an electroconductive separator plate comprising at least one landing surface formed on a surface of the separator plate, and the separator plate and landing surface comprising a polymer and conductive filler,
wherein the gas diffusion layer is joined to the separator plate by impregnating some of the polymer on the landing surface within a portion of the porous body.

2. The electrochemical cell component of claim 1, wherein the gas diffusion layer is joined to the separator plate by using a welding technique selected from the group consisting of: resistance welding, vibrational welding, ultrasonic welding, laser welding, heat lamination, and hot bonding techniques.

3. The electrochemical cell component of claim 2, wherein the welding technique is resistance welding.

4. The electrochemical cell component of claim 1, wherein the polymer is a thermoplastic polymer selected from the group consisting of melt processible polymers, partially fluorinated polymers, thermoplastic elastomers, liquid crystalline polymers, polyolefins, polyamides, aromatic condensation polymers, and mixtures thereof.

5-11. (canceled)

12. The electrochemical cell component of claim 4, wherein the polymer is a blend of about 1 wt % to about 30 wt % of maleic anhydride modified polymer with the thermoplastic polymer, partially fluorinated polymers and liquid crystalline polymer or mixtures thereof.

13. The electrochemical cell of claim 12 wherein the polymer is a blend of about 5 wt % to about 25 wt % of maleic anhydride modified polymer with the thermoplastic polymer, partially fluorinated polymers and liquid crystalline polymer or mixtures thereof.

14. The electrochemical cell component of claim 1, wherein the conductive filler is graphite fiber and graphite powder.

15. The electrochemical cell component of claim 1, further comprising a polymer rich layer on the top surface of the landing surface.

16. The electrochemical cell component of claim 15, wherein the polymer rich layer comprises between about 25 wt % and about 100 wt % polymer.

17. The electrochemical cell of claim 16 wherein the polymer rich layer comprises between about 50 wt % and about 100 wt % polymer.

18. The electrochemical cell component of claim 1, wherein the electrochemical cell component has a resistivity less than a resistivity of a system comprising a gas diffusion layer that is not welded to a plate.

19. The electrochemical cell component of claim 1, wherein the surface of the separator plate comprises open flow field channels and the gas diffusion layer does not sink into the open flow field channels.

20. An electrochemical cell comprising the cell component of claim 1.

21. An electrochemical cell stack comprising a plurality of the electrochemical cells of claim 20.
